(19) United States
(12) Patent Application Publication
(10) Pub. No.: US 2004/0047967 A1
(43) Pub. Date: Mar. 11, 2004

(54) Concentrated kavalactone beverage compositions

(76) Inventors: John Macdonough, Chenequa, WI (US); Brian Lovejoy, Santa Cruz, CA (US); Joel Mccleary, The Plains, VA (US)

Correspondence Address: FISH & RICHARDSON PC, 225 FRANKLIN ST, BOSTON, MA, 02110, US

(21) Appl. No.: 09/923,479

(22) Filed: Aug. 6, 2001

(51) Int. Cl. C12C 1/00

(52) U.S. Cl. 426/590

(57) ABSTRACT

The invention relates to an alcohol-free composition comprising high concentrations of kavalactones, compounds found in the extracts of kava-kava root. In accordance with the present invention, the compositions provide for quick relief and reduction of daily stress and anxiety in adults. The invention also relates to methods of using and making the concentrated kavalactone compositions.

### BACKGROUND

Throughout history, humans have ingested and otherwise consumed a wide variety of substances to effect relaxation, stress reduction, and an overall sense of well-being and tranquility. Examples of such substances include alcohol, marijuana, and prescription drugs (e.g., VALIUM®). However, many such substances have significant undesirable side effects, including impairment of mental faculties, involuntary sleep, adverse interaction with alcohol, user addiction, and death. Thus, many relaxants are unsafe, especially for long-term usage.

One relaxant that does not typically exhibit significant side effects is an extract from the Kava-kava root, which consists of the dried rootstock and/or shoots of Piper methysticum Forst (Family: Piperaceae). The Kava root extract is known to induce general relaxation in humans when orally ingested. An aqueous macerate of the Kava root known as “kava” or “kawa” has been used on islands in the South Pacific in social gatherings and religious rituals for centuries.

In recent years, the Kava plant has been scientifically scrutinized, with certain of its active constituents being identified. The psychoactive ingredients of the Kava root have been identified as kavalactones. A total of sixteen kavalactones have been identified to date, including kawain, dihydrokawain (a.k.a. marindinin), methysticin, dihydromethysticin, yangonin, and desmethoxyyangonin. These compounds are neutral, nitrogen-poor compounds that may be specifically referred to as substituted alpha.-pyrones. The lactone ring is substituted by a methoxy group in the C-4 position, and the compounds vary in their substitution by either a styryl residue (e.g., yangonin, desmethy-oxyyangonin, kawain, and methysticin) or by a phenylethyl residue (e.g., dihydrokawain and dihydromethysticin) at the C-6 position.

The particular kavalactones in a Kava root extract vary depending upon its origin. The concentration ranges of total kavalactone levels in the Kava root extracts employed, e.g., in the US are generally within the range of 10 to 30 wt %. Kava root extract is widely available in the world as an herbal supplement in the form of tablets, capsules, and dragees made of pharmaceutical grade extract.

The Kava root extract lactones provide an anxiolytic effect, relieving nervous anxiety, tension, and restlessness, with their efficacy as a relaxant having been demonstrated in clinical studies. The kavalactones also effect muscle relaxation. Studies have also shown that average single doses of Kava do not impair neurophysiological activity, as evidenced by such measuring indicia as recognition rates, event-related brain potentials, and driving ability (see, e.g., Munte et al, “Effects of Oxazepam and an Extract of Kava Roots (Piper methysticum) on Event-Related Potentials in a Word Recognition Task”, Neuropsychobiology 1993:27, pp. 46-53 and Russell et al, “The Effect of Kava on Alerting and Speed of Access of Information from Long-term Memory”, Bulletin of the Psychonomic Society, 25(4), pp. 23637 (1987)). Further, no addictive properties have been associated with kavalactones.

It is well established that important factors relating to the absorption rate of organic molecules through the gastrointestinal (GI) area include hydration speed and water solubility. (See, Lippincott's Illustrated reviews: Pharmacology; 2nd edition 1997, edited by R. A. Harvey et al., Lippincott Williams & Wilkins). One disadvantage of the aforementioned Kava supplements is that the active ingredients are very hydrophobic so that the formulated supplements have very poor solubility in water. (D. A-Hussain and J. Levesque, Drug Development and Industrial Pharmacy, 23(12), 1223-1226 (1997)). As a result, ingested kavalactones are excreted from a subject, and are thus not absorbed into a subjects' metabolic system. This, in part, accounts for the relatively poor efficacy of kava supplement tablets and capsules, relative to the amounts administered or ingested.

### SUMMARY

The invention relates to an alcohol-free composition (e.g., a beverage, health drink, functional beverage, nutraceutical, or nutraceutical drink) comprising high concentrations of kavalactones. The invention also relates to an alcohol-free composition (e.g., a beverage, health drink, nutraceutical, or nutraceutical drink) comprising high concentrations of active kavalactone and a stabilizer. The stabilizer contributes to the ability of the composition to include the high concentration of active kavalactones. The stabilizer can be a single material or a blend (“stabilizer blend”) of two or more stabilizer blend materials. The compositions may further comprise one or more additional ingredients, including a sweetener, a flavor agent, a fruit concentrate, or water. A health drink is a beverage that imparts any health benefit upon consumption. Health benefits include, for example, stress reduction or relief, feelings of relaxation, feelings of calmness, well-being or tranquility, reduction in anxiety, reduced blood pressure, relief from headache, and the like. Such benefits may be assessed in terms of an objective, measurable characteristic (e.g., blood pressure) or a more subjective assessment (e.g., feeling, perception, or awareness of the consumer).

In one embodiment, the invention is an alcohol-free beverage comprising about 25 mg-1000 mg (e.g., about 100 mg-500 mg, about 150 mg-300 mg, about 175 mg-500 mg, about 250 mg-500 mg, about 500 mg-1000 mg, about 50-800 mg, about 200 mg-300 mg, about 300 mg-400 mg, about 400 mg-500 mg, about 500 mg-600 mg, about 600 mg-700 mg, or about 700 mg-800 mg) of an active kavalactone selected from the group consisting of dihydrokawain, dihydromethysticin, kawain, yangonin, methylsticin, desmethoxyyangonine and a combination thereof, per 60 ml of beverage. In other embodiments, the compositions include amounts of active kavalactones delineated herein selected from the group consisting of S-(+) dihydrokawain, S-dihydromethysticin, S-(+) kawain, yangonin, S-methylsticin, desmethoxyyangonine and a combination thereof.

In another embodiment, the alcohol-free beverage further comprises a stabilizer blend having at least two stabilizers. In embodiments of the compositions herein, the stabilizer blend is 0.01% to 10.0%, alternatively 0.01% to 0.5%, alternatively 0.1% to 0.5%, alternatively 0.1% to 1.0%, or alternatively 0.05% to 2.0%, by weight, of the beverage.

The stabilizer blend includes stabilizers independently selected from carrageenan, cellulose gum, guar gum, xanthan gum, alginate, pectin, hydroxymethyl cellulose, locust bean gum, hydroxyethyl cellulose, hydroxypropyl cellulose, carboxymethyl cellulose, microcrystalline cellulose, amidated pectin, propylene glycol alginate, modified starches, maltodextrins, gelatin, polydextrose, hydroxypropylmethyl cellulose, methylcellulose, methylethyl cellulose, ethylcellulose, and combinations thereof; alternatively the stabilizers are selected from carrageen, alginate, xanthan gum, pectin, and combinations thereof.

Other aspects of the invention are any of the compositions herein further having one or more of the following: a preservative (e.g., an anti-oxidant, an anti-microbial); a sweetener (e.g., a natural sweetener, such as sugar); a flavor agent (e.g., a natural flavor agent, such as one or more of rosemary, grapefruit seed, cinnamon, ginger, cardamom and clove, vanilla, or chocolate, or combinations thereof); a fruit concentrate (e.g., passion fruit, cranberry, or mango, citrus (e.g., grapefruit, orange, lemon, lime), citrus bioflavanoids, or combinations thereof); or water. Another embodiment is any composition delineated herein further having a stabilizer blend having at least two stabilizers, a sweetener, a flavor agent, a fruit concentrate, and water.

Other aspects of the invention are any of the compositions delineated herein wherein the beverage is a health beverage; wherein the beverage induces relaxation in the consumer, wherein the beverage reduces stress in the consumer; wherein the active kavalactones include synthetic active kavalactones; wherein the active kavalactone is the primary active ingredient; wherein the active kavalactone is the sole active ingredient; wherein the active kavalactone is the sole herbal derived ingredient; wherein the composition is void of an effective amount of a Plantago major extract; and wherein the composition is void of any Plantago major extract.

Another aspect of the invention relates to a method of making any of the compositons delineated herein (e.g., an alcohol-free beverage) comprising combining 25 mg-1000 mg of an active kavalactone selected from the group consisting of dihydrokawain, dihydromethysticin, kawain, yangonin, methylsticin, desmethoxyyangonine and a combination thereof per 60 ml of beverage, and a stabilizer including a blend having at least two stabilizers. The method can further include combining a sweetener, a flavor agent, a fruit concentrate, and water.

The beverage compositions are pleasant tasting and refreshing. They are also formulated to provide desirable organoleptic qualities (e.g., pleasant mouthfeel, throatfeel, flavor). The stabilizer blend (e.g., gums) can additionally truncate, or diminish, the unpleasant flavor notes of the kava extract in the composition. Such modulation provides an overall more pleasing sensation and organoleptic perception to the consumer.

In accordance with the present invention, a health beverage is provided for quick relief and reduction of daily stress and anxiety in adults, comprising an effective amount of emulsified active kavalactones. Upon consumption of the beverage compositions, consumers experience a variety of feelings, including of relaxation, stress-relief, reduction in anxiety, and calmness. The invention provides emulsified active kavalactones having a surface area for hydration that is greater than that of the kava extract in the usual kava extract powder in a capsule or a tablet, thus allowing for absorption of the active kavalactones at an increased and more efficient rate than that of kava extract in capsule or tablet form. The invention also provides compositions having high concentrations of kavalactones in minimal volumes, due in part to the blend of stabilizers present in the compositions. Such concentrations are significantly higher than alcohol-free compositions using kava extract or kavalactones. Such concentrations also allow for greater therapeutic effects of kavalactones relative to other compositions. The present beverage therefore enhances the general relaxation achieved from the consumption of Kava root compared to that of Kava root extract consumed in tablet or capsule form.

### DETAILED DESCRIPTION

An active kavalactone is a kavalactone selected from the group consisting of dihydrokawain, dihydromethysticin, kawain, yangonin, methylsticin, desmethoxyyangonine, and a combination thereof. Alternatively, the active kavalactone is a kavalactone selected from the group consisting of S-(+) dihydrokawain, S-dihydromethysticin, S-(+) kawain, yangonin, S-methylsticin, desmethoxyyangonine, and a combination thereof. Active kavalactones may be obtained from the kava kava root using various extraction methods, including simple solvent soak, CO₂ extraction, supercritical fluid extraction (SFE). They (or the extract) can be further purified by chromatographic methods. The active kavalactones can also be synthesized from readily available starting materials by conventional chemical methods. See, for example, Kostermans, Reclk. Trav. Chim. Pays-Bas., 70, 79 (1951); Klohs et al., J. Org. Chem., 24, 1829 (1959); Spino, et al. Tetrahedron Lett., 37, 6503 (1996), and references cited in each. Through conventional chemical synthesis and purification methods, active kavalactones can be made in >90%, alternatively >95% purity. The active kavalactones present in a composition can be enriched by addition of those kavalactones (from either natural or synthetic sources). The active kavalactones (e.g., dihydrokawain, dihydromethysticin, and kawain) can contain one or more asymmetric centers and thus can occur as racemates and racemic mixtures, single enantiomers, individual diastereomers and diastereomeric mixtures. They can also occur in cis- or trans- or E- or Z-double bond isomeric forms. All such isomeric forms can be used in the compositions herein.

In the compositions herein, the kavalactones, including the active kavalactones, can be the primary active ingredient, the sole active ingredient, the sole herbal derived ingredient, the sole herbal derived primary active ingredient, or the sole herbal derived active ingredient of the composition. If it is the primary active ingredient, the kavalactones provide the primary, or predominate, identified activity or benefit (e.g., physiologic effect, health benefit, anxiolytic effect, tension or stress reduction effect, calmness effect, or focus effect). If it is the sole active ingredient, the kavalactones solely provide the identified activity or benefit (e.g., physiologic effect, health benefit, anxiolytic effect, tension or stress reduction effect, calmness effect, or focus effect). If it is the sole herbal derived ingredient, the kavalactones are the only component of the composition derived from an herbal source. If it is the sole herbal derived primary active ingredient, or the sole herbal derived ingredient, it is the only primary active ingredient, or the sole active ingredient (as mentioned above) derived from an herbal source, respectively. In such instances, additional ingredients including for example, a sweetener, a flavor agent, a fruit concentrate, water, or a preservative, are not considered an “active” ingredient, although they might in a lesser manner contribute some indistinguishable benefit. One herb, Plantago major, is known to contain a component, “Purpureaside A”, that shows toxicity related to a decrease of human leukocyte function (i.e., an immunosuppressive effect). See, for example, H. Ravan et al., Phytochemistry, 1990, 29, 3627;1988, 27, 3433; J. Molnar et al., Acta Microbio.l Hung., 1989, 36(4) 425. Thus, because of the potential toxicity of Purpureaside A, it is desirable to avoid any extracts, or components, derived from Plantago major. Other embodiments of the invention are compositions delineated herein that are devoid of an effective amount of a Plantago major extract, that is an amount of extract sufficient to provide a physiological property of Plantago major extract (e.g., tobacco aversion, reduction in tobacco craving). Other embodiments are compositions delineated herein that are devoid of any Plantago major extract.

An “alcohol-free” composition refers to a composition that is essentially devoid of any alcoholic content. A composition is essentially devoid of alcohol if it contains less than 5.0% (e.g., <0.5%, <1%, or <3%) alcohol content.

A sweetener is a material that imparts sweetness to the composition, that is, imparts the sensation of sweetness to the taste of the subject consuming the composition. Sweeteners useful in the compositions herein include, for example, a sugar of any type, including disaccharides (sucrose, lactose or maltose) and monosaccharides (e.g., glucose and fructose). Sucrose is a water soluble sugar obtained from sugarcane, sugar beets, sorghum, maple sugar, and the like. Sucroses can be solid or liquid in form including, for example, sucrose, cane sugar, beet sugar, medium invert, and the like. Sucroses can also be in the form of a syrup or a saturated aqueous solution. A specific sucrose useful in the compositions is cane sugar. Fructose is a fruit sugar that is also useful in the compositions herein. Fructoses are extremely sweet and a natural by-product of fruits, honey, plants, and vegetables. Fructose can be solid or liquid in form including, for example, granular fructose and liquid fructose. Alternatively, an artificial sweetener (e.g., aspartame, saccharin, acesulfame-K, sucralose) or a sugar alcohol (e.g., sorbitol, xylitol, mannitol) may be used in the composition.

A subject is any creature that can consume, ingest, or be administered the compositions of the invention, including a mammal (e.g., human, dog, cat, horse), animal, marine creature, reptile, fish, and the like.

A stabilizer blend is a combination of two or more materials (e.g., stabilizers, hydrocolloids, colloidal gums, or dispersants) that enhance the ability of two heterogeneous materials (e.g., oil and water) to intermingle. Such substances can cause thickening of the composition, and aid in making the composition more homogeneous. Stabilizer blend materials aid in forming an emulsion, or dispersion, or suspension of finely divided liquid particles disposed in another liquid. The stabilizer blends of the composition contribute to the dispersion of the active kavalactones throughout the composition, particularly as the composition includes increasing proportions of active kavalactones relative to water. The stabilizer blends of the composition allow increased amounts of the active kavalactones to be disposed in a particular volume (e.g., lesser) of the composition compared to the same volume of composition without the stabilizer or stabilizer blend, including in compositions having significant amounts of water therein. Additionally, the stabilizer blend contributes to the enhancement of bioavailability or ADME properties (absorption, distribution, metabolism, excretion) of the active kavalactones upon consumption of the composition by a subject.

Stabilizer blend materials that can be used in the stabilizer blends of the invention include carrageen, cellulose gum, guar gum, xanthan gum, alginate, pectin, hydroxymethyl cellulose, locust bean gum, hydroxyethyl cellulose, hydroxypropyl cellulose, carboxymethyl cellulose, microcrystalline cellulose, amidated pectin, propylene glycol alginate, modified starches, maltodextrins, gelatin, polydextrose, hydroxypropylmethyl cellulose, methylcellulose, methylethyl cellulose, ethylcellulose, and combinations thereof. The compositions typically contain about 0.001% to about 4.0%, alternatively about 0.01% to about 3.0%, or about 0.05% to about 2.0%, or about 0.1% to about 1.5% of the stabilizer blend by weight.

Juice concentrates used in the compositions may be of fruit or vegetable origin including, for example, passion fruit, cranberry, mango, citrus (e.g., grapefruit, orange, lemon, lime), citrus bioflavanoids, and the like. Juice concentrates may be used singly or on combination.

The water used in the compositions can be filtered (e.g., charcoal, reverse osmosis) or deionized. The water may be non-carbonated or carbonated. Alternatively, other liquids, including juices or teas may be used in place of water.

A “concentrate” is a concentrated form of the material at issue.

The compositions can also include other ingredients, for example, flavor agents, vitamins, and preservatives. A “flavor agent” is an ingredient that imparts a flavor in the taste of the composition. The flavor agent may be a natural or an artificial flavor. The flavor agent may be made of a single flavor or a plurality of individual flavors combined. The flavor agents can be combined in the compositions delineated herein singly, in combination, or as a premixed combination. The flavor agents can be fruit, vegetable, herb, or spice, or other more general food and beverage flavoring agents (e.g., sweet flavor). Flavor agents include, for example, rosemary, grapefruit seed, cinnamon, ginger, cardamom, apple, coconut, vanilla, chocolate, or clove. Flavor agents also include fragrances or other agents that impart an aroma to the composition, for example, valerolactones.

A “vitamin” or “vitamin source” is a vitamin, including its derivative forms (e.g., salts) or an entity that can undergo transformation under typical metabolic conditions (e.g., upon ingestion and entry into or passage through the digestive system) to the vitamin. Vitamins, include for example, vitamin C, ascorbic acid, vitamin A, vitamin E, β-carotene, and the like.

Preservatives useful in the invention may be natural or artificial. Preservatives include anti-oxidants (e.g., ascorbic acid, tocopherol), antimicrobial agents (e.g., potassium sorbate, sodium benzoate), as well as sugar and grapefruit seed extract.

The invention also relates to methods of making the compositions delineated here, comprising combining an active kavalactone selected from the group consisting of dihydrokawain, dihydromethysticin, kawain, yangonin, methylsticin, desmethoxyyangonine and a combination thereof, and a stabilizer blend (e.g., a blend having at least two gums). The method can further comprise the step, or steps, of combining one or more additional agents, such as a sweetener, a flavor agent, a fruit concentrate, or water. The combining of these additional agents can be accomplished by addition of each agent individually, or alternatively, as a premixed combination of additional agents. Such agents may be combined in a dry state, a liquid state, or as a solution in a suitable solvent (e.g., water). The combining of the ingredient, or mixture of ingredients, can be done in any order.

The methods of preparing the compositions delineated herein can utilize standard apparatuses, conditions and protocols known in the art. Mixing vessels can be made of any suitable material (e.g., stainless steel, glass). The vessels may include an agitation mechanism, (e.g., stirrer, paddle, jet spray, shaker) that is part of the vessel or separate, either in direct contact with the mixture or such that the vessel itself is in motion, thus imparting a mixing effect on the contents. In the methods herein, the order of addition of any ingredient or combinations of ingredients can be varied. Ingredients in dry form may be added dry, or alternatively as a solution in an appropriate liquid.

All references cited herein, whether in print, electronic, computer readable storage media or other form, are expressly incorporated by reference in their entirety, including but not limited to, abstracts, articles, journals, publications, texts, treatises, technical data sheets, internet web sites, databases, patents, patent applications, and patent publications.

Embodiments are further described in the following representative examples, which do not limit the scope of the invention described in the claims.

### EXAMPLES

### Examples 1-5

Health drink compositions according to the invention were manufactured from Kava extracts (Kavalactones), fruit concentrates, sugars, natural flavors, stabilizer blends (e.g., stabilizers, carrageen, or gums) according to the formulas set forth in Table 1. The active kavalactones are obtained from kava extract or synthesized, and can be obtained from commercial sources, such as KAVIAR purchased from Cosmopolitan Trading, Seattle, Wash. The remaining ingredients are readily available from commercial sources as well. The stabilizer blend exemplified was TIC PRETESTED Colloid 1004 T Powder (Xanthan Gum, Sodium alginate) and TIC PRETESTED Pectin Pre-hydrated 1694 Powder, available from TIC Gums, Inc., Belcamp, Md. Vanilla and chocolate extracts are available from R. R. Lochead, Paso Robles, Calif. Cassia (cinnamon), rosemary, and grapefruit seed (as CO2 extracts) are available from Primal Essence. The sweetener used was beta-pure evaporated cane sugar available from Wholesome Foods, Savannah, Ga. Passion fruit concentrate is AP Passion Fruit concentrate available from ITI Tropicals, Inc., Lawrenceville, N.J. With the resultant health drink compositions of the invention, the recipients can effectively reduce daily stress and anxiety, and increase their focusing ability.

TABLE 1
Compositions

| Ingredient | | | | | |
|---|---|---|---|---|---|
| (amount in 60 ml | Example No. | | | | |
| of composition) | 1 | 2 | 3 | 4 | 5 |
| Kava extract (mg) | 330 | 500 | 833 | 1500 | — |
| (Kavalactones) | (100) | (150) | (250) | (500) | (150) |
| Sugars (g) | 18.5 | 22.5 | 22.5 | 22.5 | 22.5 |
| Fruit | 2.0 | 2.7 | 2.7 | 2.7 | 2.7 |
| concentrates (g) | | | | | |
| Natural | 1.7 | 2.2 | 2.5 | 3.0 | 2.2 |
| Flavors (g) | | | | | |
| Water (g) | 46 | 40 | 30 | 25 | 40 |
| Stabilizer | 115 | 120 | 120 | 130 | 120 |
| Blend (mg) | | | | | |

In the case of Example 5, purified Kavalactones (>95%) were used.

What is claimed is:

1. An alcohol-free beverage comprising 25 mg-1000 mg of an active kavalactone selected from the group consisting of dihydrokawain, dihydromethysticin, kawain, yangonin, methylsticin, desmethoxyyangonine and a combination thereof, per 60 ml of beverage.

2. The beverage of claim 1, further comprising a stabilizer blend having at least two stabilizers.

3. The beverage of claim 1, wherein the active kavalactone is selected from the group consisting of S-(+) dihydrokawain, S-dihydromethysticin, S-(+) kawain, yangonin, Smethylsticin, desmethoxyyangonine and a combination thereof.

4. The beverage of claim 1, comprising 100 mg-500 mg of an active kavalactone per 60 ml of beverage.

5. The beverage of claim 1, comprising 500 mg-1000 mg of an active kavalactone per 60 ml of beverage.

6. The beverage of claim 2, wherein the stabilizer blend is 0.01% to 10.0%, by weight, of the beverage.

7. The beverage of claim 2, wherein the stabilizers are independently selected from carrageenan, cellulose gum, guar gum, xanthan gum, alginate, pectin, hydroxymethyl cellulose, locust bean gum, hydroxyethyl cellulose, hydroxypropyl cellulose, carboxymethyl cellulose, microcrystalline cellulose, amidated pectin, propylene glycol alginate, modified starches, maltodextrins, gelatin, polydextrose, hydroxypropylmethyl cellulose, methylcellulose, methylethyl cellulose, ethylcellulose, and combinations thereof.

8. The beverage of claim 7, wherein the stabilizers are selected from carrageen, alginate, xanthan gum, pectin, and combinations thereof.

9. The beverage of claim 1, further comprising a preservative.

10. The beverage of claim 9, wherein the preservative is an anti-oxidant.

11. The beverage of claim 9, wherein the preservative is anti-microbial.

12. The beverage of claim 1, further comprising a sweetener.

13. The beverage of claim 12, wherein the sweetener is a natural sweetener.

14. The beverage of claim 13, wherein the sweetener is sugar.

15. The beverage of claim 1, further comprising a flavor agent.

16. The beverage of claim 15, wherein the flavor agent is a natural flavor agent.

17. The beverage of claim 16, wherein the flavor agent is selected from rosemary, grapefruit seed, cinnamon, ginger, cardamom and clove.

18. The beverage of claim 1, further comprising a fruit concentrate.

19. The beverage of claim 18, wherein the fruit concentrate is passion fruit, cranberry, mango, grapefruit, orange, lemon, lime, or combination thereof.

20. The beverage of claim 1, further comprising water.

21. The beverage of claim 1, further comprising a stabilizer blend having at least two stabilizers, a sweetener, a flavor agent, a fruit concentrate, and water.

22. The beverage of claim 1, comprising the following ingredients in their respective amounts by weight per 60 ml of beverage:

| | |
|---|---|
| Kavalactones | 150-250 mg |
| Sugars | 15-30 g |
| Fruit concentrates | 2-4 g |
| Natural flavors | 1.5-3.0 g |
| Water | 20-50 g |
| Stabilizer blend | 0.05-0.2 g. |

23. The beverage of claim 1, comprising the following ingredients in their respective amounts by weight per 60 ml of beverage:

| | |
|---|---|
| Kavalactones | 100-500 mg |
| Sugars | 15-30 g |
| Fruit concentrates | 2-4 g |
| Natural flavors | 1.5-3.0 g |
| Water | 20-50 g |
| Stabilizer blend | 0.05-0.2 g. |

24. The beverage of claim 1, comprising the following ingredients in their respective amounts by weight per 60 ml of beverage:

| | |
|---|---|
| Kavalactones | 350-500 mg |
| Sugars | 10-30 g |
| Fruit concentrates | 1.5-3.0 g |
| Natural flavors | 1.5-3.0 g |
| Water | 20-50 g |
| Stabilizer | 0.05-0.2 g. |

25. The beverage of claim 1, wherein the beverage is a health beverage.

26. The beverage of claim 1, wherein the beverage induces relaxation in the consumer.

27. The beverage of claim 1, wherein the beverage reduces stress in the consumer.

28. The beverage of claim 1, wherein the active kavalactones include synthetic active kavalactones.

29. A method of making an alcohol-free beverage comprising combining 25 mg-1000 mg of an active kavalactone selected from the group consisting of dihydrokawain, dihydromethysticin, kawain, yangonin, methylsticin, desmethoxyyangonine and a combination thereof per 60 ml of beverage, and a stabilizer including a blend having at least two stabilizers.

30. The method of claim 29, further comprising combining a sweetener, a flavor agent, a fruit concentrate, and water.
